(19) United States
(12) Patent Application Publication
(10) Pub. No.: US 2016/0302438 A1
(43) Pub. Date: Oct. 20, 2016

(54) METHOD FOR THE PREPARATION OF A CHOCOLATE PRODUCT

(71) Applicant: KRAFT FOODS R&D, INC., Deerfield, IL (US)

(72) Inventor: Rosemary Jean Brown, Birmingham (GB)

(21) Appl. No.: 15/102,515

(22) PCT Filed: Jan. 6, 2015
(86) PCT No.: PCT/IB2015/050087

§ 371 Date: Jun. 7, 2016

(30) Foreign Application Priority Data
Jan. 6, 2014 (GB) 1400151.5

(51) Int. Cl. A23G 1/00; A23G 1/54

(52) U.S. Cl. CPC A23G 1/0063; A23G 1/545; A23G 2220/20; A23G 2220/22; A23V 2002/00

(57) ABSTRACT

A method for preparing a chocolate product and products producible by the method. The method comprises applying a stamp (12) or roller to a plastic or flowable chocolate composition (8) in a mould (4). The method may further comprise removing the stamp or roller prior to allowing the composition to solidify or set. Alternatively the method may comprise partially or completely solidifying the composition before removal of the stamp such that the composition retains the shape/texture of the stamp or roller when removed. In one embodiment the method comprises preparing a shell (2) from a first chocolate composition within a mould (4). The shell is then filled with a filling material (6) and a second chocolate composition (8) is deposited into the mould to provide a coating, backing or lid. The stamp (12) or roller is applied to the surface of the second chocolate composition (8) such that a closed cavity is formed by the mould (4) and stamp (12).

The present invention relates to a chocolate product and a method for the preparation thereof. In particular, the invention relates to a method for preparing a chocolate product which comprises applying a stamp or roller to moulded chocolate.

Confectionery bars continue to be popular with consumers, in particular chocolate bars. Many varieties of chocolate bars are available, including bars of solid chocolate, and bars of chocolate comprising a contrasting filling such as caramel, fruit, nuts, biscuit, aerated chocolate, fudge, fondant etc.

However, there is still a need for new and varied chocolate products in order to appeal to the consumer. In particular, there is a need for chocolate products which are visually interesting as well as having interesting flavours and mouthfeel.

According to a first aspect of the invention, there is provided a method for preparing a chocolate product comprising applying a stamp or roller to a plastic or lowable chocolate composition in a mould.

By “plastic” it will be understood that the chocolate composition is in a semi-solid state which is capable of being formed or shaped. A chocolate composition in a plastic state is not completely liquid or flowable, nor is it completely solidified. In the plastic state the composition is capable of retaining the shape/texture of the applied stamp or roller once the plate or roller has been removed, without having to wait for the composition to completely solidify or set while the stamp or roller is in place.

By “flowable” it will be understood that the chocolate composition is in a substantially liquid or molten state such that the composition is not capable of being formed or shaped. In this state, after application of the stamp or roller, the composition must be partially or completely solidified before removal of the stamp or roller from the composition in order for the composition to retain the shape/texture of the stamp or roller.

In one series of embodiments the plastic or flowable chocolate composition has a temperature of no more than 43° C., no more than 40° C., no more than 37° C., no more than 34° C. or no more than 31° C. when the stamp or roller is applied.

In one series of embodiments the plastic or flowable chocolate composition has a temperature of at least 16° C., at least 17° C., at least 18° C. or at least 19° C. when the stamp or roller is applied. It is difficult to introduce a shape into a chocolate composition having a temperature of less than 16° C.; the chocolate has a tendency to crack.

The chocolate composition is deposited into a mould, after which it may be passed beneath a roller. Alternatively, a stamp may be applied to the chocolate composition.

In some embodiments, the stamp or roller is chilled. The stamp or roller may have a temperature of no greater than 10° C., no greater than 5° C., no greater than 2° C. or no greater than 0° C. In some embodiments, the temperature of the chilled stamp or roller is less than 0° C., less than −5° C., less than −10° C. or less than −15° C.

In one series of embodiments the stamp or roller has a temperature of at least −15° C., at least −5° C. or at least −2° C. Higher temperatures provide a more economical process.

In some embodiments, the chilled stamp or roller is applied to a flowable chocolate composition. The use of a chilled stamp or roller accelerates the cooling and solidification of the flowable chocolate composition.

The stamp or roller may be chilled prior to and/or during its application to the chocolate composition. Cooling of the stamp or roller prior to contact with the chocolate composition may be achieved by holding the stamp or roller in a cold environment, or by placing it in contact with a cold liquid or gas. Alternatively, or additionally, the stamp or roller may comprise an intrinsic cooling means, for example cooling channels.

In some embodiments a temperate stamp is used. By “temperate” it will be understood that the stamp is neither substantially heated nor substantially cooled prior to contact with the chocolate composition. The temperature of the stamp could be up to the temperature of the chocolate composition, for example it could be up to around 30° C. It will be appreciated that the air temperature in a moulding plant is likely to be above the 20° C. that is often designated as room temperature and that a temperature of 30° C. could be considered temperature, given the environment. In some embodiments, the stamp is at approximately room temperature when it is applied to the composition. In some further embodiments, the temperature of the stamp may be raised or lowered by a few degrees relative to room temperature in order to achieve a desired quality of surface finish. For example, the temperature of the stamp may be increased or decreased by no more than 5° C. or no more than 3° C., compared to the localised air temperature prior to application of the stamp to the chocolate composition. A temperate stamp may therefore be at a temperature of from 10 to 30° C., from 15 to 25° C. or from 18 to 22° C., e.g. 20° C., if, for example, the room temperature was 20° C. The use of a temperate stamp as opposed to a cold stamp facilitates the retrofit of the invention to existing production lines where there may not be a convenient supply of coolant or refrigerant to maintain the tools in a cooled state. Furthermore, there are economic benefits to using a temperate stamp as opposed to a cooled stamp. It will be appreciated that where a temperate stamp is used it will be necessary to retain the stamp in contact with the chocolate composition for a longer period of time as, in order to result in a clean imprint in the chocolate composition that does not become distorted by the pull out of the stamp or roll off of the roller the chocolate composition will need to achieve a certain level of rigidity (which will vary dependent on the exact constitution of the product). In contrast a cooled stamp or roller will accelerate the relative cooling, and therefore the setting of the chocolate composition, and allow for the stamp or roller to remain in contact with the chocolate composition for a shorter period of time before it can be reliably removed.

The stamp or roller may be applied to a chocolate composition which is in a plastic (i.e. semi-molten) state. Thus, in some embodiments, the chocolate composition is partially cooled prior to the application of the stamp or roller. Since the composition is in a plastic state, it is not always necessary for the stamp or roller to be chilled in order to impart shape or texture to the chocolate composition (although in some embodiments it may be preferred to use a chilled stamp or roller). It will be appreciated that the exact temperature and viscosity of the composition at which the stamp is applied to it will depend on the type of chocolate, its rate of solidification, and other production line specific parameters. In a production line the stamp will be applied to each product at a particular point in the line and that point will be determined by the rate of cooling that takes place on the line to that point.

In some embodiments the stamp or roller is transiently applied to the chocolate composition. By “transiently applied” it will be understood that the stamp or roller does not have prolonged contact with the chocolate composition, i.e. it does not remain in place throughout the solidification process. In some embodiments the stamp or roller is applied to the chocolate composition for as short a time as is sufficient for a surface of the chocolate composition to retain the shape of the stamp or roller. This method may be particularly suited to the use of cooled stamps or cooled rollers. In one embodiment, the stamp or roller may be applied until the chocolate reaches a temperature of no more than 16° C., such as from 13 to 16° C.

A temperate stamp plate or roller may be applied to the chocolate composition for no more than 60 minutes, no more than 45 minutes, no more than 30 minutes, no more than 20 minutes, no more than 15 minutes or no more than 10 minutes. A chilled stamp or roller may be applied to the confectionery composition for no more than 5 minutes, no more than 3 minutes, no more than 2 minutes or no more than 1 minute. If, however, a chilled stamp is being applied to a semi-solid chocolate that is already partially cooled, and is therefore more viscous, a contact time in the order of seconds, for example 0.25 to 3 seconds, or 0.5 to 1.5 seconds is sufficient. In one embodiment the stamp or roller has a temperature of no more than −2° C. and the stamp or roller is applied to the chocolate composition for no more than 3.5 seconds. The inventors have discovered that a shape can be imprinted on chocolate in a plastic state under these conditions.

After removal of the stamp or roller from the chocolate composition, the composition may then be subjected to a further or final cooling step to sufficiently complete the solidification process. In particular, when using a cooled stamp or roller, after removal of the stamp or roller it will be necessary to continue to cool the product so that it is solid enough to be removed from the mould and/or packaged. This will be done using a final cooling step or steps for which parameters in the ranges of 5° C.-20° C. air temperature, 1-8 m/sec air speed at the point of control and 10-45 minutes residence time, may be applied. It will be appreciated that these parameters will vary with product and production line parameters, for example the ambient temperature and/or the extent of the cooling/solidification of the product that has occurred during the stamping or rolling process. The exit temperature of the product after the cooling step will be sufficiently high to be above the dew point to avoid condensation on the product, but will be low enough that the product is not in a molten state, or too soft to be handled in downstream operations.

In some alternative embodiments, the stamp may remain in contact with the molten chocolate composition until the composition has sufficiently solidified. In particular when using a temperate stamping process it may be necessary for the stamp or roller to remain in contact with the chocolate composition until the product is sufficiently solidified that it can be removed without distorting the imprint or the surface in which the imprint has been formed. The chocolate composition will be at least partially, and optionally fully, cooled with the stamp in place. The cooling time when using a temperate stamp may vary from that of an unstamped product as the stamp remains in place during at least part of the cooling cycle. As the stamp has a thermal mass this will also need to be cooled and the heat extracted from the chocolate composition will need to pass through the stamp or roller. The extent of any increase in cooling time will be dependent upon the nature of the stamp; in particular it will depend upon the thermal conductivity of the stamp material, and the relative dimensions thereof.

In some embodiments, the stamp may comprise a stamping plate which is applied to a chocolate composition in a mould such that the stamping plate and the mould form a 2-part cavity. The stamping plate may remain in place until the composition has sufficiently solidified, after which the stamping plate is removed and the final product is de-moulded. In some further embodiments, the stamp and/or the mould is temperate. Where a stamping plate is used the stamping plate may substantially cover the entire area of the back side of the moulded chocolate product and as such may distribute the product in the mould as it is applied, in particular this may be of benefit where the product is of a relatively high viscosity, for example it is viscous liquid or plastic material when added to the mould and does not naturally flow to form a flat level surface in the mould.

The chocolate composition could be a milk chocolate, a dark chocolate or a white chocolate. As used herein, a “chocolate composition” is a confectionery composition comprising at least non-fat cocoa solids and/or cocoa butter and optionally CBR (CBE and/or CBS). The term “chocolate composition” should be construed as covering not only chocolate compositions which can be sold as “chocolate” in countries where chocolate is legally defined, but also chocolate compositions which, because of fat, cocoa content etc. may not be legally described as “chocolate” in those countries.

A suitable milk chocolate composition comprises non-fat cocoa solids and milk solids in addition to the bulk sweetener and fat.

A suitable dark chocolate composition comprises non-fat cocoa solids in addition to the bulk sweetener and fat.

A suitable white chocolate composition comprises a bulk sweetener and at least one of cocoa butter/CBE/CBS.

The chocolate composition may be a low-fat chocolate composition, in which case the chocolate composition has a fat content of less than 25 wt % or less than 23 wt %. The chocolate composition may have a fat content of at least 16 wt %, at least 18 wt % or at least 20 wt %.

Suitable milk solids include cream, full fat milk, skimmed milk and/or whey. The chocolate composition may be prepared from powdered milk solids such as powdered milk/cream or whey powder. Useful sources of whey include whey protein concentrate, whey protein isolate, whey protein hydrolysate or a combination thereof. The whey may be demineralised.

In some embodiments the chocolate composition comprises bulk sweetener, cocoa butter, non-fat cocoa solids and milk solids. In a particular embodiment the chocolate composition comprises 40-70 wt % sucrose, 15-30 wt % cocoa butter, 2-10 wt % non-fat cocoa solids and 10-20 wt % milk solids

In some alternative embodiments the chocolate composition comprises 45-55 wt % bulk sweetener, 25-30 wt % cocoa butter substitute, 10-15 wt % demineralised whey, 4-8 wt % non-fat cocoa solids and 0-2 wt % cocoa butter.

The chocolate may comprise a cocoa butter substitute (CBS) (sometimes known as a cocoa butter replacer, CBR) in place of some or all of the cocoa butter. Such chocolate materials are sometimes known as compound chocolate. Suitable CBS's include CBS laurics and CBS non-laurics. CBS laurics are short-chain fatty acid glycerides. Their physical properties vary but they all have triglyceride configurations that make them compatible with cocoa butter. Suitable CBS's include those based on palm kernel oil and coconut oil. CBS non-laurics consist of fractions obtained from hydrogenated oils. The oils are selectively hydrogenated with the formation of trans acids, which increases the solid phase of the fat. Suitable sources for CBS nonlaurics include soya, cottonseed, peanut, rapeseed and corn (maize) oil.

In one embodiment the plastic or flowable chocolate composition is a plastic chocolate composition. A chocolate composition may be plastic at from 19 to 22° C. In one embodiment a plastic chocolate composition is obtained by tempering chocolate and then cooling the tempered chocolate to a temperature of from 19 to 22° C.

In one embodiment the plastic or flowable chocolate composition is a flowable chocolate composition. A chocolate composition may be flowable at a temperature of from 22 to 32° C., or from 27 to 30° C.

The stamp or roller is not completely immersed in the chocolate composition so as to form the overall shape of the chocolate product, but instead it is applied so as to shape, decorate or emboss an external surface of the chocolate product. The stamp or roller may be only immersed in the chocolate composition to a depth which is sufficient to form an impression in the surface of the composition. Thus, in some embodiments, the method is for shaping, decorating or embossing an external surface of a chocolate product. In some embodiments, the external surface of the chocolate product is substantially planar. In some embodiments, the stamp or roller is applied to the external surface of the chocolate composition which forms the base of the final chocolate product.

In some embodiments the stamp or roller comprises a bearing surface having one or more projections or indentations which are capable of imparting letters, shapes, numbers, pictures, patterns, logos, texture and/or other design features to the surface of the chocolate composition to which it is applied. It may be desirable to immerse only the projections of a bearing surface in the chocolate composition in order to create the desired effect. In one series of embodiments the projections/indentations have a depth of no more than 20 mm, no more than 15 mm, no more than 10 mm or no more than 5 mm. In one series of embodiments the applying the stamp or roller to the chocolate composition comprises immersing the stamp or roller to a depth of no more than 20 mm, no more than 15 mm, no more than 10 mm or no more than 5 mm.

The bearing surface of the stamp or roller may be adapted to form shapes or patterns such as flowers, stars, bark, honeycomb, grids, zig-zags, strips, waves, spots, snowflakes, animals, faces, bubbles, ripples, shells, waves, scales, chains, geometric patterns or the like into the surface of the chocolate composition. In one particular embodiment the stamp may be a pattern that includes break lines to indicate to the consumer where to break the bar. These break indicators may optionally be aligned with areas of weakness in the bar, for example they may coincide with areas of reduced product depth between adjacent sections of the bar that would not otherwise be apparent from the face of the bar into which the pattern is stamped.

In some alternative embodiments the stamp or roller has a substantially smooth bearing surface, i.e. with no design features. In these embodiments, the purpose of the stamp may be to evenly distribute the chocolate composition within the mould and/or to provide an even, smooth surface.

In some embodiments, the stamp is substantially planar i.e. it comprises a stamping plate. A planar stamping plate is particularly suitable for applying decoration to a substantially planar surface of a chocolate product, for example, to the base of a chocolate bar.

The stamping plate can be considered to have a mutually perpendicular length and width (measured in the plane of the plate, typically parallel to the base of the mould). In one embodiment at least one of the length and the width is at least 50, 70, 100 or 150 mm. A large stamping plate allows the plate to be in contact with substantially the entire back of a chocolate product.

In some embodiments, the method comprises applying a roller to the chocolate composition. The use of a roller is advantageous in that it enables a large surface area to be shaped, decorated and/or embossed quickly by moving the roller over the surface of a chocolate composition deposited in moulds, while the chocolate composition is in a plastic state. It will be appreciated that the shape, pattern or decoration created in the chocolate composition will be dependent on the spacing of the complementary indentations/projections in or on the surface of the roller, and on the diameter of the roller. Rollers within the present invention are not limited only to drum type, i.e. substantially cylindrical, rollers but may comprise two or more cylindrical rollers having a belt carrying individual press faces on it, i.e. the rolling element may be formed as a belt such that it has a section that runs parallel to the production line. In this way the contact time of the rolling element and the product passing down the production line can be extended compared to a standard cylindrical roller. The stamp features of the roller, i.e. the roller drum or the stamp plates attached to the rolling belt are preferably cooled. Using a roller the contact time of the stamp element and the chocolate is limited to the duration for which the product is under the roller and therefore will be of a relative short duration. Cooling the stamp feature of the roller will enable the chocolate to solidify, at least locally, around the stamp such that upon removal of the stamp the imprint is retained. Although any convenient material may be used, in order to maximise the speed of heat transfer heat from the stamp part of the cooled roller, the roller is preferably made of a material having a high thermal conductivity, preferably a metal. In order to minimise the adhesion of chocolate to the stamp it may be coated with a material that does not readily adhere to the chocolate product, in particular with a material having a low coefficient of friction. Furthermore coatings that minimise problems associated with condensation on the rollers or the stamps of roller belts may be used, for example the coating may be hydrophobic. Although a hydrophobic coating will not prevent condensation it will result in condensation not adhering to the stamps or rollers which will prevent or reduce the effect of accumulated condensation from building up into large drops of water which could case defects in product quality.

The speed of rotation of the roller will be matched to the linear speed of the throughput of the plant at the point of stamping and may be in the range of 4 m/minute to 30 m/minute

The chocolate product may be a bar (a chocolate bar). The bar may be solid (i.e. formed entirely from the chocolate composition), or it may comprise a filling.

In some embodiments, the method comprises:

preparing a shell from a first chocolate composition within a mould;

filling the shell with a filling material;

depositing a second chocolate composition into the mould to provide a coating, backing or lid; and

applying a stamp or roller to the surface of the further chocolate composition.

In some embodiments, the method may further comprise applying vibration to the mould to evenly distribute the deposited second chocolate composition within the mould.

In some embodiments, a stamp is applied to the further chocolate composition such that the stamp and the mould together form a two-part moulding cavity. The second chocolate composition may then be cooled before the stamp is removed and the resulting product is de-moulded.

The first and second chocolate compositions may be the same or different.

Any suitable filling material may be used, such as aerated or non-aerated fat-based fillings. The filling material may comprise chocolate (e.g. milk, white or dark chocolate), praline, mousse, nougat, caramel, fondant, biscuit, Turkish delight, marshmallow, honeycomb, peanut butter, nuts, fruit, wafer, cookie or mixtures thereof.

In some embodiments, the method comprises preparing and filling a plurality of shells in adjacent moulds. The second chocolate composition may be deposited over each individual mould, thereby forming a plurality of individual coated chocolate products. Alternatively, the second chocolate composition may be deposited over the plurality of filled shells such that the plurality of shells are linked by a backing or base formed from the second chocolate composition.

In some embodiments, a stamping plate having a substantially smooth bearing surface forms a part of a 2-part moulding cavity. This is particularly useful wherein the chocolate composition is deposited as a backing, coating or lid onto a filled shell or a plurality of shells within a mould. The stamping plate maintains the shape of the chocolate composition and ensures that none of the composition spills out of the mould during cooling. This eliminates the need to remove excess chocolate from the final product (e.g. by scraping).

In some further embodiments, the method is for shaping, decorating and/or embossing the exterior surface a chocolate product, the method comprising applying a chilled stamp or roller to a surface of a chocolate composition in a mould, wherein the surface forms an external surface of the chocolate product. The chilled stamp or roller may be applied to the chocolate composition for no more than 5 seconds, no more than 3 seconds or no more than 2 seconds. The method may further comprise removing the chilled stamp or roller from the chocolate composition, and cooling the composition until it has sufficiently solidified.

In other embodiments, the method is for shaping, decorating or embossing the exterior surface of a chocolate product, the method comprising:

depositing a chocolate composition in a mould;

partially cooling the chocolate composition until it is in a plastic state; and

applying a temperate stamp or roller to a surface of the partially cooled chocolate composition.

The temperate stamp may be held in contact with the chocolate composition for as short a time as is sufficient for the surface of the chocolate composition to retain the shape of the stamp or roller. The temperate stamp or roller may be applied to the chocolate composition for less than 30 seconds, less than 10 seconds, or less than 5 seconds. The method may further comprise removing the stamp or roller from the chocolate composition, after which the chocolate composition is further cooled until solidified. The resulting chocolate product may then be de-moulded. It will be appreciated that if the stamp is removed prior to complete solidification of the chocolate composition then the composition will have cooled sufficiently so as to retain the imprint created by the stamp once it is removed.

In some embodiments, the method is for shaping, decorating or embossing the external surface of a chocolate product, the method comprising:

preparing a shell from a first chocolate composition within a mould;

filling the shell with a filling material;

depositing a second chocolate composition into the mould to provide a backing, coating or lid;

applying a temperate stamp to the surface of the second chocolate composition such that the stamp and the mould form a 2-part cavity;

allowing the second chocolate composition to solidify before removing the stamp; and

de-moulding the chocolate product.

The invention also resides in a product producible by the method of this embodiment.

In some embodiments, the mould and stamp form part of the packaging of the chocolate product. Alternatively or additionally, the mould and/or stamp may constitute an additional product which is packaged together with the chocolate product. For example, a stamp which is used to shape, decorate or emboss the surface of the chocolate product may also function as a toy or a tool which can be used by the consumer. Therefore, the stamp and/or mould, as a constituent of the product and/or packaging, may remain in contact with the chocolate composition during cooling, storage, distribution and retail, and would be removed when unwrapped by the consumer.

Thus, in some embodiments, the method comprises depositing a chocolate composition into a mould;

applying a stamp to the chocolate composition while it is in a molten or semi-molten state;

cooling the chocolate composition without removing the stamp; and

packaging or wrapping the solidified chocolate composition and the stamp as a single product.

The invention also resides in a product producible by the method of this embodiment.

Optionally the mould may also form part of the final packaged product.

This process eliminates the need to de-mould and then re-package the solidified chocolate, thereby making the process more efficient. In addition, the stamp has a dual use in that it provides decoration or interest to the chocolate product, but also forms part of the final product and can be re-used by the consumer. For example, the stamp may provide a children's toy which can be used for decorating, shaping or embossing other substances such as foods or modelling clay.

The stamp or roller may be made from any suitable material such as metal (e.g. aluminium) or plastic (e.g. polycarbonate). It is preferred that the material from which the stamp or roller is made enables efficient heat transfer from the chocolate composition. The inventors have discovered that a stamping plate made from aluminium sheet of thickness 2 mm enables efficient heat transfer such that cooling is comparable to cooling without a stamping plate. The material may be rigid or it may be flexible, and it may be of any suitable thickness. In one embodiment the stamp or roller is made from a material having a thickness of no more than 5 mm or no more than 3 mm. In some embodiments, the material is semi-porous to allow the release of gas from the chocolate composition.

It will be appreciated that when applying a stamp or roller to the chocolate some of the chocolate will be displaced by the stamp or roller. In order to compensate for this the mould containing the plastic or flowable chocolate will not be filled to capacity. Furthermore to ensure that there are no air bubbles trapped beneath the stamp the stamp will be designed such that the material will flow around it expelling any air. Depending on the nature of the shape being stamped into the chocolate it may be necessary to provide the stamp plate or roller with air removal routes or tracks, which may route the air to an outer edge of the stamp, or may include holes through the stamp to allow air to escape therethrough.

Embodiments of the invention will now be described by way of example with reference to the accompanying figures in which:

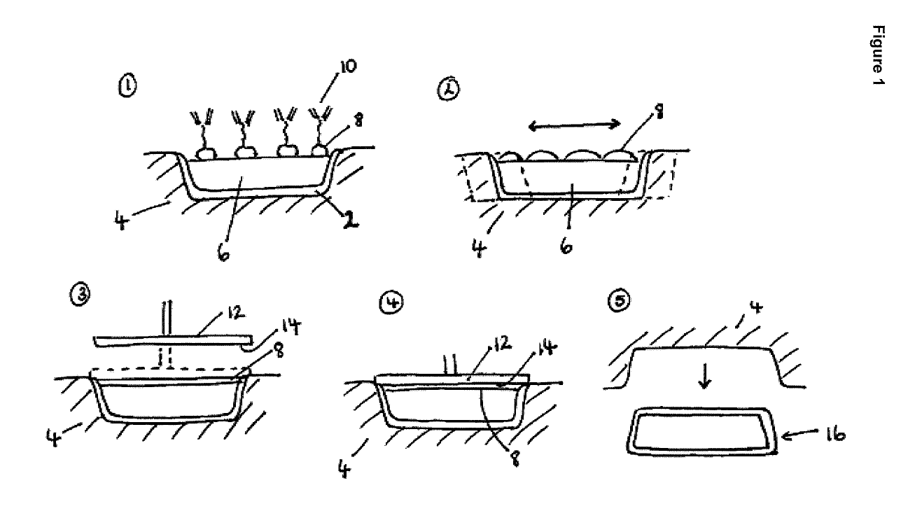

FIG. 1 is a diagram showing the stages of a method according to an embodiment of the invention, in which a stamping plate forms part of a 2-part mould cavity;

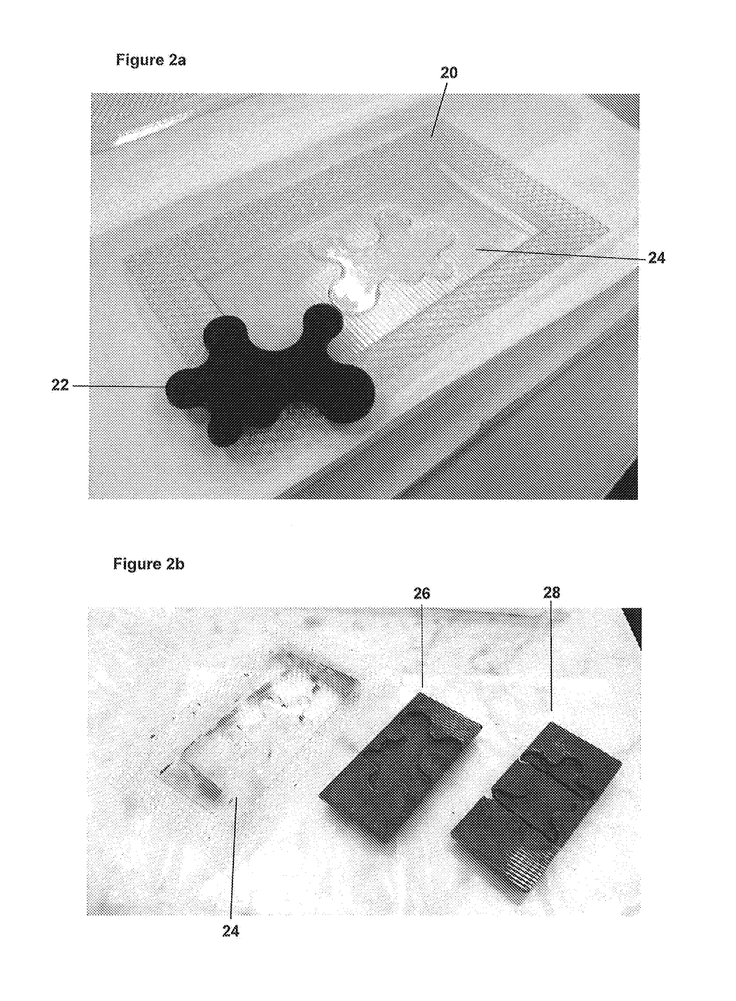

FIG. 2a shows an example of a stamping plate for use in a method according to an embodiment of the invention;

FIG. 2b shows chocolate bars produced using the stamping plate of FIG. 2a, in accordance with an embodiment of the invention;

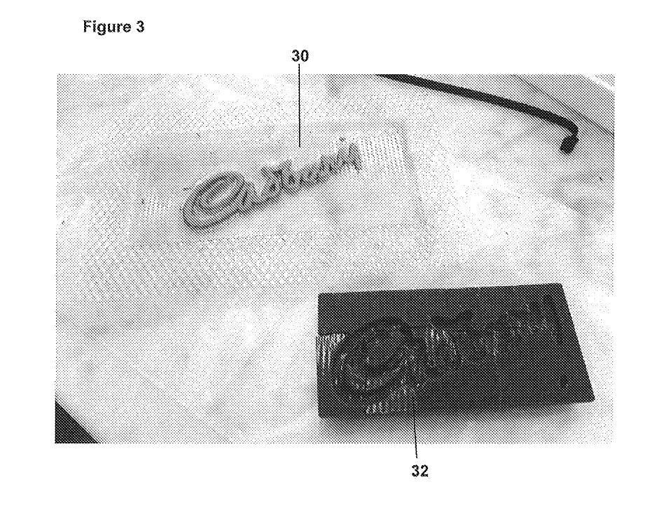

FIG. 3 shows a further example of a stamping plate for use in a method according to an embodiment of the invention, together with a chocolate bar produced using the stamping plate;

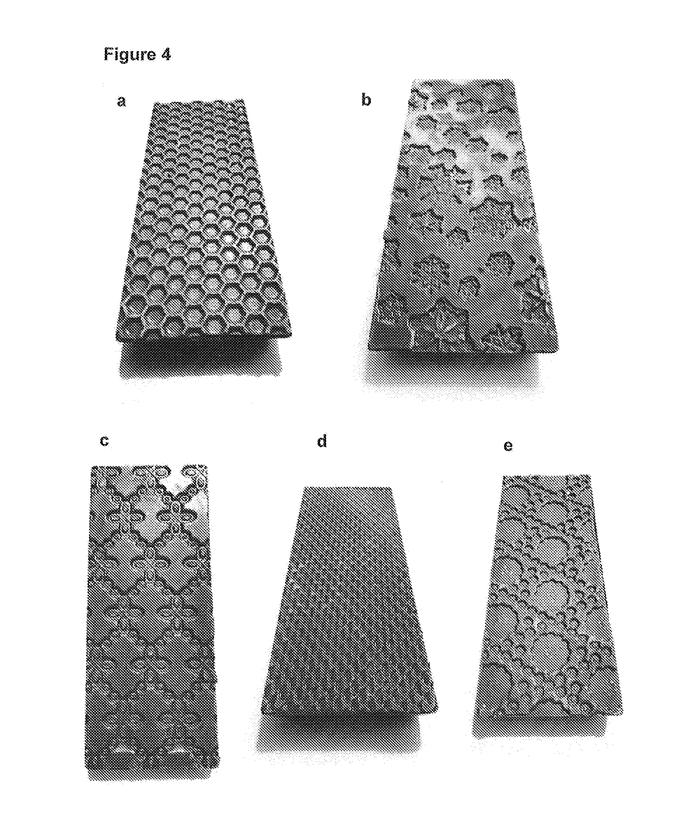

FIGS. 4a-4d show chocolate bars produced in accordance with a method of the invention;

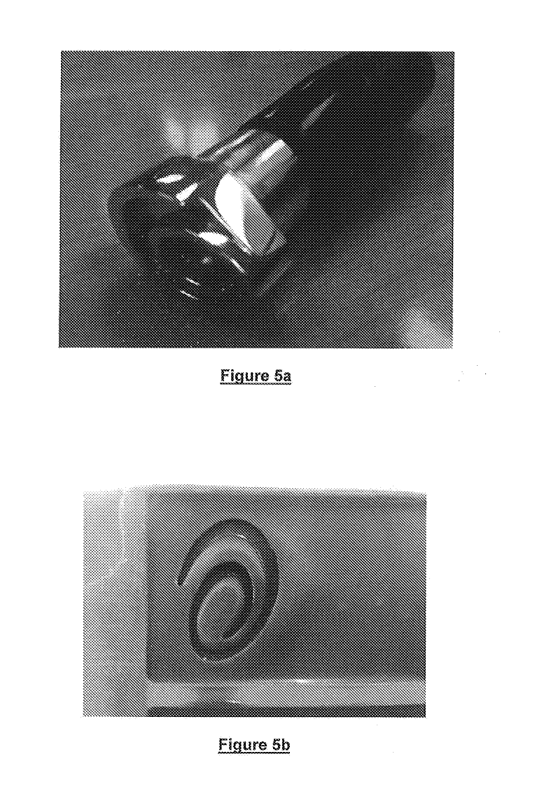

FIG. 5a shows an example of a stamp of the invention; and

FIG. 5b shows a product stamped with the stamp shown in FIG. 5a.

### EXAMPLE 1

With reference to FIG. 1, a chocolate shell 2 is first prepared in a mould 4 by standard methods known to those skilled in the art. The chocolate shell 2 is filled with a chocolate filling material 6. On top of the filling material 4 is deposited a chocolate composition 8 by depositer nozzles 10 (step 1). The chocolate composition 8 is then evenly distributed over the filling material 6 by applying vibration to the mould 4 (step 2). A stamping plate 12 is then applied to the chocolate composition 8 such that a closed cavity is formed by the mould 4 and the stamping plate 12 (step 3). The stamping plate 12 has a bearing surface 14 which is in contact with an outer surface of the chocolate composition 8 such that the surface of the chocolate composition 8 takes the shape of the bearing surface 14. The stamping plate 12 remains in place while the chocolate composition 6 is cooled (step 4). After the chocolate composition 8 has sufficiently solidified, the stamping plate 12 is removed and the resulting chocolate product 16 is de-moulded (step 5).

### EXAMPLE 2

A vacuum form 20 was formed out of 0.75 mm PET using a template 22, as shown in FIG. 2a. The vacuum form 20 constitutes a stamping plate 24 which can be used to decorate chocolate products with the shape of the template 22. The depth of the shape projecting from the surface of the stamp was approximately 5 mm and could be pressed into the chocolate to different depths by hand. A molten chocolate composition was deposited into a mould (not shown) agitated to evenly distribute it. The stamp was then applied to the chocolate white it was in a flowable state and the mould, together with the stamp, was then refrigerated to cool for approximately 5 minutes to set the chocolate. The resulting chocolate bar was de-moulded. The process was repeated, in which the stamping plate 24 was pressed more lightly into the chocolate composition. The results are shown in FIG. 2b. A chocolate bar 28 produced by the initial test cracked because the stamping plate 24 was pressed too far into the chocolate composition, causing very thin regions of chocolate. A chocolate bar 26 produced by the second test did not show any cracking since the stamping plate was not pressed as far into the chocolate composition. In both cases, the shape of template 22 was successfully replicated in the chocolate. The shape had well-defined edges.

### EXAMPLE 3

The method of example 2 was repeated to test whether letters could be successfully printed into chocolate. A stamping plate 30 was made using a template of the “Cadbury” logo. The logo was successfully transferred into the base of a chocolate bar 32 with high definition, as shown in FIG. 3. No cracking of the chocolate occurred, although air entrapment in the chocolate was observed. In this product the reverse side of the chocolate bar was moulded to define a rectangular array of chunks of chocolate, joined by raft sections on the bottom the bar (resulting tin the substantially flat base seen in FIG. 3 which shows the logo stamped into the reverse of the bar. As will be appreciated the product is only stamped to a depth that does not compromise the strength of the raft sections joining the chunks so as to avoid unintentional breaking of the bar.

### EXAMPLE 4

The method of example 2 was repeated using stamping plates in the form of textured plastic sheets. Stamping plates with various designs were tested to investigate the level of detail and definition that could be achieved using chocolate. The stamping plates were applied to the surface of a chocolate composition in a mould which forms the base of the resulting chocolate product. The results are shown in FIGS. 4a-4e. Patterns including honeycomb (FIG. 4a), snowflakes (FIG. 4b) and other geometric patterns (FIGS. 4c-4e) were replicated with a surprising level of definition, providing interesting texture and detail to the base of the chocolate bars.

### EXAMPLE 5

In this example tests were run in order to achieve a uniform surface cooling of the bars. The stamp used in this example was a manual hand stamp having a metal stamp head as depicted in FIG. 5a. A plurality of bars were moulded at ambient temperature using tempered chocolate (27.6° C.) and were placed in a cooler after approximately 1 min and left in the cooling simulator for approximately 50 sec. The air flow speed in the simulator was 2 m/s and the air temperature was set at 14° C. A cold stamp at −18° C. was applied 40 seconds after the bars were taken out of the cooler. Each consecutive stamp was in contact with the bar for an average of 2 seconds. The resulting shapes were in this case well defined as depicted in FIG. 5b.

### EXAMPLE 6

The successful example 5 employing a chilled stamp having a temperature of −18° C. was investigated using higher temperatures, which are more economical. Well tempered MILKA milk chocolate was deposited at 29° C. into a mould. The cooling simulator was set at 13° C. with an air flow speed of 2 m/s.

| Case | 6a | 6b | 6c | 6d | 6e | 6f | 6g |
|---|---|---|---|---|---|---|---|
| Total cooling time | 03:30 | 03:00 | 01:55 | 01:55 | 03:00 | 03:35 | 03:25 |
| (minutes) | | | | | | | |
| Residence time in | 50 s | 40 s | | | 41 | 45 | 34 |
| cooler (s) | | | | | | | |
| Stamp temperature | −13 | −13 | −13 | −2 | 3.5 | 0 | −2 |
| (° C.) | | | | | | | |
| stamping time (s) | 1 s | 1 s | 1.4 | 3.2 | 1.3 | 1.3 | 1.2 |

The results were assessed with respect to the definition of the resulting shape on the bar, the ease with which the stamp was released and whether or not the chocolate would stick to the stamp:

| | |
|---|---|
| 6a | chocolate already too solid hard to stamp (chocolate not plastic) |
| 6b | well defined shape no sticking |
| 6c | well defined shape no sticking |
| 6d | well defined shape no sticking but longer stamping time |
| 6e | slight sticking of chocolate on stamp causing problems when |
| | releasing quickly |
| 6f | less sticking of chocolate on stamp depending on stamp depth |
| 6g | well defined shape no sticking |

The trials showed that the best results were achieved when the cooling time was around 3 minutes, allowing the chocolate to reach a semi-solid (plastic) state before stamping.

Stamp temperatures as high as −2° C. provided good results. Above that temperature, depending also on the solidification stage and the depth of the stamp, the chocolate tended to stick more on the stamp. When the cooler was not employed the stamping time had to be marginally longer to provide an acceptable result and the temperature no higher than −2° C.

A rolling stamp was also tested which gave similar results and could speed up the process.

It was also noted that open stamp shapes (as in FIG. 5b) worked better than closed shapes when a flat surface is desired. An open shape allows the chocolate to flow around the shape and be level. A solid shape, e.g. a solid circle, could provide an uneven surface.

### EXAMPLE 7

Simulation work was carried out in order to understand the heat conduction through cooling when the chocolate surface is covered by a stamping plate. The plate was applied for the duration of the simulation with an initial condition of mould, chocolate and stamp at 30° C. (303K). In all simulations the mould material and thermal conductivity remained constant therefore the main change between simulations was the heat transfer through the top surface of the mold, exposed to air. The simulation was run for 1500 s for two different heat conductivity plates (polycarbonate and aluminium) and two different thicknesses (2 and 4 mm).

| | Final average temperature (K) |
|---|---|
| Mould only (no stamp) | 281.5 |
| 2 mm polycarbonate stamp | 282.0 |
| 4 mm polycarbonate stamp | 282.6 |
| 2 mm aluminium stamp | 281.5 |
| 4 mm aluminium stamp | 282.0 |

The results showed that depending on thickness, the plate material can impede heat transfer. When a small thickness aluminium plate was used the heat transfer was comparable to that of the case where no stamp was used. In all the cases where a stamp was used the temperature range within the chocolate was reduced which could mean a more uniform cooling and a better final product.

For the initial modelling strategy the latent heat generation due to crystallisation (phase change) has been excluded in all simulations. This allows scenarios to be compared but cooling rates and times may be different to experimental results where heat is generated during the phase change.

1. A method for preparing a chocolate product comprising applying a stamp or roller to a plastic or flowable chocolate composition in a mould.

2. The method of claim 1 wherein the chocolate product is a plastic composition, the method further comprising removing the stamp or roller prior to allowing the composition to solidify or set.

3. The method of claim 1 wherein the chocolate product is a flowable composition, the method further comprising partially or completely solidifying the chocolate before removal of the stamp such that the composition retains the shape/texture of the stamp or roller when removed.

4. The method according to claim 1 further comprising depositing the chocolate composition into a mould and thereafter passing said mould containing the chocolate composition beneath a roller.

5. The method according to claim 1 further comprising depositing the chocolate composition into a mould and thereafter applying a stamp to the chocolate composition in the mould.

6. The method according to claim 1 wherein the stamp or roller is chilled.

7. The method according to claim 6 wherein the stamp or roller has a temperature of no greater than 10° C., no greater than 5° C., no greater than 2° C. or no greater than 0° C.

8. The method according to claim 6, wherein the chilled stamp or roller is applied to the chocolate composition when the chocolate composition is in a semi-solid state, for a time period in the range of: 0.25 to 3 seconds or 0.5 seconds to 1.5 seconds.

9. The method according to claim 1 comprising applying a stamp to the chocolate product and wherein the stamp is temperate.

10. The method according to claim 9 wherein the stamp has a temperature in the range of 10° C. to 30° C., 15° C. to 25° C. or 18° C. to 22° C.

11. The method according to claim 2 further comprising, after removal of the stamp or roller from the chocolate composition, cooling the composition to further solidify the chocolate product.

12. The method according to claim 1 comprising applying a stamp to the chocolate product and wherein the stamp comprises a stamping plate which is applied to a chocolate composition in a mould such that the stamping plate and the mould form a 2-part cavity.

13. The method according to claim 6 comprising applying a stamp to the chocolate product and wherein the stamp comprises a stamping plate that substantially covers the entire area of the back side of the moulded chocolate product and during its application distributes the product in the mould as it is applied.

14. The method according to claim 1 wherein the stamp or roller is applied to the external surface of the chocolate composition which forms the base of the final chocolate product.

15. The method according to claim 1 wherein the stamp or roller comprises a bearing surface, said bearing surface being: a smooth bearing surface or a bearing surface having one or more projections or indentations thereon.

16. The method according to claim 1 further comprising:
preparing a shell from a first chocolate composition within a mould;
filling the shell with a filling material;
depositing a second chocolate composition into the mould to provide a coating, backing or lid; and
applying said stamp or roller to the surface of the second chocolate composition.

17. The method according to claim 1 comprising applying a stamp to the chocolate product, the method further comprising cooling the chocolate composition without removing the stamp, and packaging or wrapping the solidified chocolate composition and the stamp as a single product.

18. The method according to claim 4 wherein the moulds are provided on a moving conveyor and wherein the roller comprises a continuous belt mounted on at least one rolling element and arranged such that a section of said belt is parallel to the moving conveyor; the method further comprising:
operating the roller such that at least parts of the belt, or plates mounted to said belt, come into contact with the composition within the moulds, and
operating the roller such that at least in the section parallel to the moving conveyor, its speed is equal to that of the moving conveyor such that as the mould passes below the roller on the conveyor there is substantially no relative movement between the parts of the roller in contact with the chocolate composition and the moulds.

19. A moulded chocolate product producible by the process of claim 1, having a front side and a back side and wherein a pattern or print is pressed into the back side.

20. A moulded chocolate product according to claim 19 further comprising a stamp plate embedded in the back side

21. A moulded chocolate product according to claim 19 wherein the chocolate product comprises a filled chocolate product.
